(19) United States
(12) Patent Application Publication
(10) Pub. No.: US 2013/0255118 A1
(43) Pub. Date: Oct. 3, 2013

(54) Illuminated Yard Sign

(71) Applicant: Kelly Warren, Gretna, LA (US)

(72) Inventor: Kelly Warren, Gretna, LA (US)

(21) Appl. No.: 13/438,459

(22) Filed: Apr. 3, 2012

(51) Int. Cl. G09F 13/04

(52) U.S. Cl. 40/572; 40/564

(57) ABSTRACT

An outdoor sign, which can be formed in a any desired shape corresponding to a sports team logo, political party logo or an event mascot. The outdoor sign has a planar front panel and a planar back panel securable in parallel relationship with their inner surfaces facing each other. The back panel has a total surface area greater than the front panel. The inner surface of the back panel is formed light-reflective to reflect the light generated by light members secured to the inner surface of the front panel. An upright support is detachably securable to the front panel and the back panel to support the sign above the ground.

### BACKGROUND OF THE INVENTION

This invention relates to temporary outdoor signs and, more particularly, to yard signs that that may be temporarily mounted to the ground using an embedded stake.

It is a common practice to mount temporary signs in the front yards of homes and other areas of high visibility. The signs can be advertising signs, real estate signs, yard sale signs, political election signs, or seasonal signs. Such signs are temporarily mounted when installed and then removed shortly after the election, property sale, completion of a yard sale and the like.

Conventional signs have rectangular configuration and formed of a single panel displaying information on only one side and attached to a sign support, such as a long wooden stake, by staples, nails, or similar mechanical means. Such signs are relatively inexpensive and not durable. They are typically made of card stock coated with polyethylene. The image is either printed or scored on the front surface of the sign panel.

Another known yard signs are made of corrugated plastic. Various types of ink are used for imprinting indicia on the sign. In some cases, UV resistant ink is used to improve visibility of the sign message. The industry has also developed two sided signs which are formed by two sheets stapled together or by a single folded-over sheet with the edges joined, as by staples, or sealed by a hot melt adhesive, creating an inverted pocket to receive a sign support, such as an inverted, rectangular, U-shaped wire support, the legs of which are pushed into the ground.

There are currently a couple deficiencies existing in the industry. One deficiency is that almost all yard signs are formed as planar rectangular bodies differing only in the type of indicia imprinted on the faces of the sign. Some municipalities have rules restricting the size of the sign and the height of the supporting stake. Such signs have low visibility because they can be easily obstructed by vegetation in the front yard. Additionally, these signs are not visible at night.

The present invention contemplates elimination of drawbacks associated with conventional yard signs and provision of a highly visible fanciful sign that can be cut out by a user using a kit with various templates representing sports teams in amateur and professional leagues.

### SUMMARY OF THE INVENTION

It is, therefore, an object of the present invention to provide a yard sign that has high visibility at night.

It is another object of the invention to provide a kit of making a yard sign comprising an image of a sport team.

It is a further object of the present invention to provide a kit with templates of cutouts representing a variety of sport teams.

It is still an object of the present invention to provide a kit for making an illuminated yard sign.

These and other objects of the invention are achieved through a provision of an outdoor sign, which can be formed in a any desired shape corresponding to a sports team logo, political party logo or an event mascot. The outdoor sign has a front panel and a back panel securable in parallel relationship with their inner surfaces facing each other. The back panel has a total surface area greater than the front panel. The inner surface of the back panel is formed light-reflective to reflect the light generated by an illumination assembly secured to the inner surface of the front panel. An upright support is detachably securable to the front panel and the back panel to support the sign above the ground.

### BRIEF DESCRIPTION OF THE DRAWINGS

Reference will now be made to the drawings, wherein like parts are designated by like numerals, and wherein

FIG. 1 is a perspective view of a yard sign according to the present invention.

FIG. 2 is a plan view of the kit components for making a yard sign according to the present invention.

FIG. 3 is an exploded view showing components for making an exemplary fleur-de-lis yard sign.

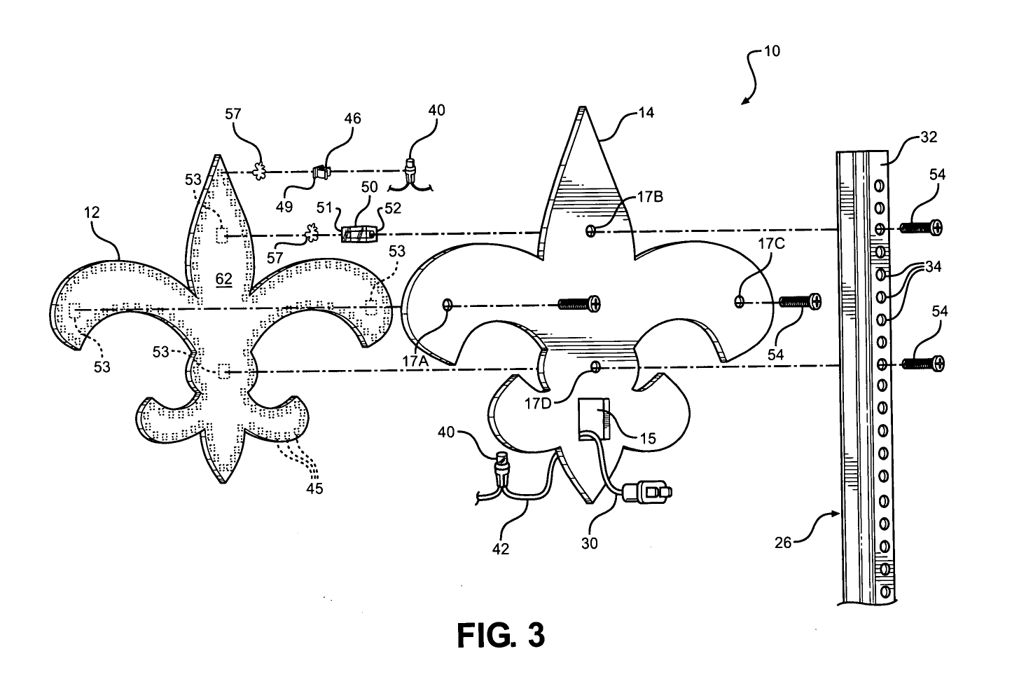

FIG. 4 is a detail view showing positioning of the light members and spacer blocks installed on the front panel.

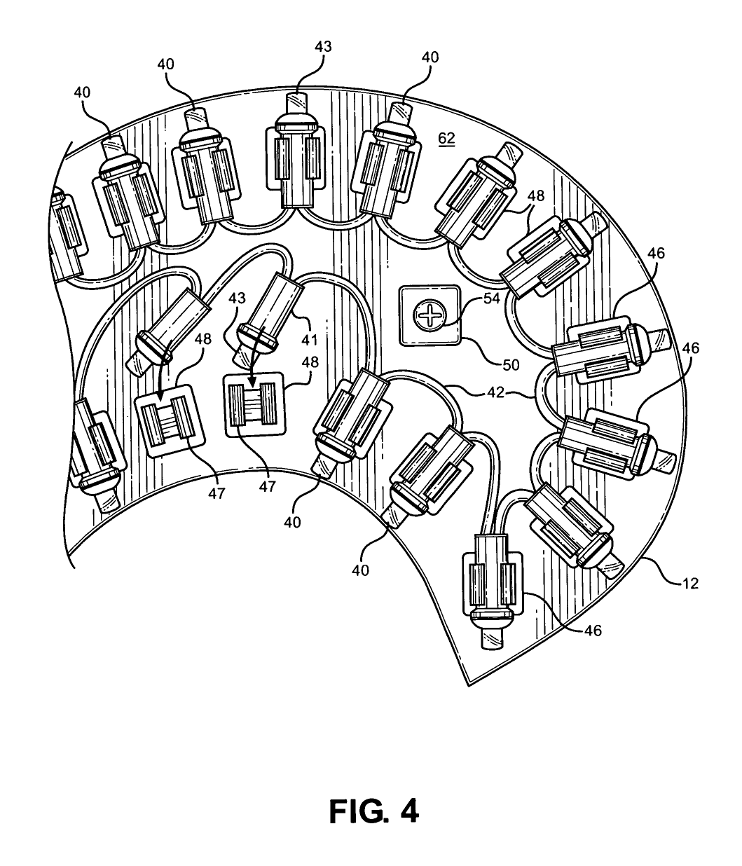

### DETAIL DESCRIPTION OF THE INVENTION

Turning now to the drawings in more detail, numeral 10 designates the yard sign device according to the present invention. The yard sign device comprises a first front panel 12 and a second back panel 14. In the exemplary embodiment shown in the drawings, the front and back panels have a fleur-de-lis configuration. It will be understood that the configuration of the panels is arbitrary and depends on the template selected by the user from a number of templates included in a sign making kit 20. The templates can be for any fanciful design, including logos of sport teams, for instance university football teams, basketball teams, professional league teams, etc.

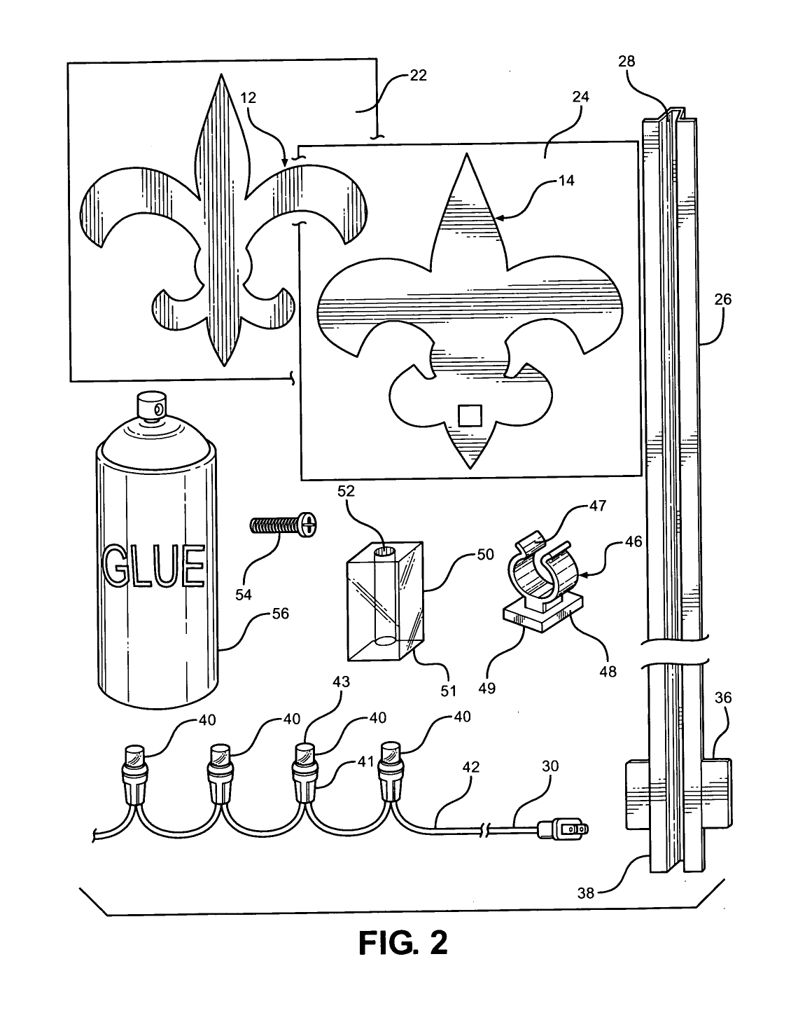

The kit 20, as shown in FIG. 2, has two planar sheets 22, 24, on which the outline of the panels 12 and 14 is made by printing or scoring. The planar sheets can be formed from a variety of materials. In one aspect of the invention, the planar sheets 20 and 24 are formed from Signabond®, aluminum composite panels. Such panels have a solid polyethylene core, aluminum layers on both sides and a protective film covering the aluminum layers. Such panels are available in a variety of colors and sizes; they are moisture impervious and easy to cut. Of course, other weather resistant materials can be used for making the panels 12 and 14.

The kit 20 also comprises an upright stake 26, which can be formed from a variety of materials, such as aluminum, plastic, etc. The stake 26 comprises an elongated body of a pre-determined length to correspond to the length of upright supports allowed in the municipality, where the yard sign 10 is to be placed. The stake 26 has a generally U-shaped groove 28 extending along its substantially entire length. The groove 28 is sized and shaped to accommodate a length of an electrical cord 30. A rear wall 32 of the stake 26 is provided with a plurality of spaced apertures 34 for securing the panels 12 and 14, as will be described in more detail hereinafter.

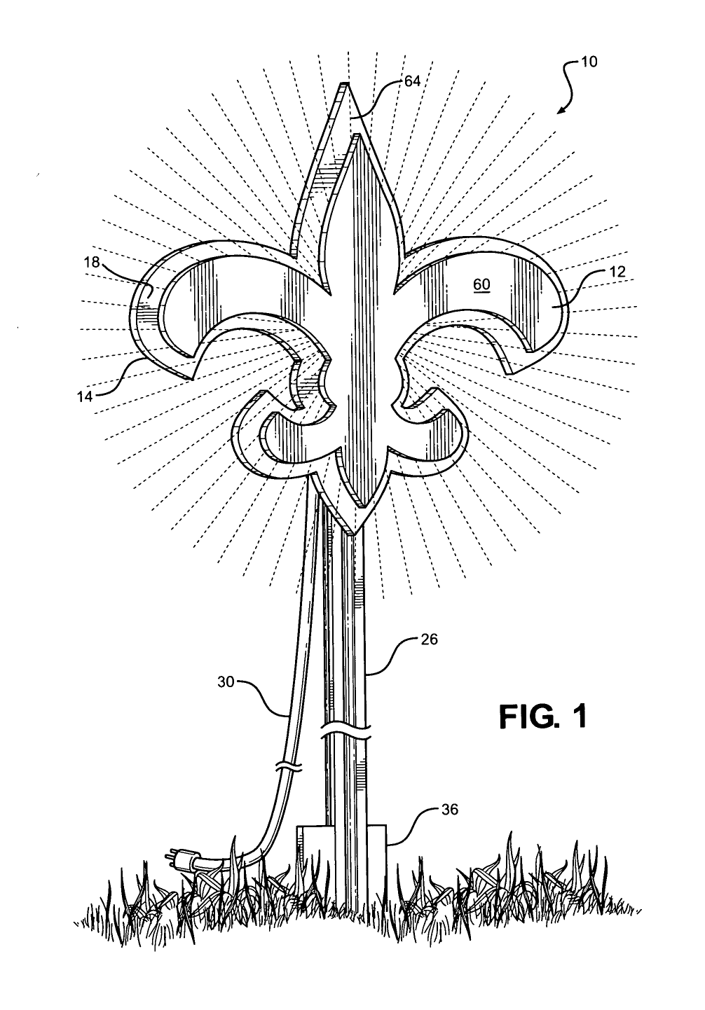

The stake 26 can be formed as a T-bar stake, which carries a transverse bar 36 affixed a distance above a bottom end 38 of the stake 26. The transverse bar 36 acts as a foot push allowing the user to easily embed the stake 26 into the ground. The transverse bar 36 can be formed from a solid plate, as shown in FIGS. 1 and 2 or as a rod secured to the stake 26. Any manner of securing the transverse bar 36 can be used, including welding, molding, adhesive, etc.

The kit 20 further comprises an illumination assembly, which has a set of electric or LED light members 40 connected in series by conventional wiring 42. One end of the wire 42 is connected to the electrical cord 30, so that the string of lights 40 can be illuminated using a source of AC power, such as a municipal power source. Each of the light members 40 has a light base 41, which has a generally cylindrical configuration and a light element 43 fitted in the base 41. In one aspect of the invention, the light elements 43 are detachably secured within their respective bases 41 and can be replaced if damaged or malfunctioning. The light elements 43 can be of any desired color.

The illumination assembly in the kit 20 also includes a plurality of light clips 46, which can be conventional clips having a U-shaped engaging part 47 sized and shaped to receive the light base 41 of the light member 40. Each of engaging parts 47 is provided with an attachment member 48, which can be formed as a planar piece having a flat outer surface 49. If desired, the inner surface 62 of the front panel 12 can be provided with markings 45 designating the places where the clips 46 need to be attached. Similarly, markings 53 can be used for designating the places where the spacer blocks 50 will be secured.

The kit 20 also includes a plurality of spacer blocks 50 designed to fit between the front panel 12 and the back panel 14 and retain them at a predetermined distance from each other. In the exemplary embodiment shown in the drawings, four such spacer blocks 50 are provided. Each spacer block 50 is formed as a solid body having an opening 52 formed therein. At least a part of the opening 52 is threaded to receive a threaded bolt or screw 54. A plurality of such bolts (screws) is provided in the kit 20. A back surface 51 of each spacer block 50 is preferably flat for easy attachment of the spacer blocks 50 to the front panel 12.

A container 56 with an adhesive material is included in the kit 20. The adhesive material in the container 56 is suitable to adhesively secure the attachment members 48 of the clips 46 and the spacer blocks 50 to the front panel 12 in a manner described below. In one aspect of the invention, the clips 46 and the spacer blocks 50 are formed from a non-corrosive material, for instance plastic. Therefore, the adhesive in the container 56 is selected to be suitable for such applications.

The front panel 12 has a pre-determined total surface area, which is smaller than a pre-determined total surface of the back panel 14, such that when the front panel 12 is secured to the back panel 14 a peripheral border 18 is defined about the periphery of the back panel 14. The front panel 12 has an outer surface 60 and an inner surface 62. The back panel 14 has an inner surface 64 and an outer surface 68. In the preferred embodiment, the inner surface 64 of the back panel 14 is white or has a light reflective surface. When the panels 12 and 14 are secured together the inner surfaces 62, 64 face each other, separated by the spacer blocks 50.

When making the yard sign of the present invention, the user selects the type of a kit the user wishes to make from a plurality of available templates. The example illustrated in the drawings shows a fleur-de-lis yard sign. The user cuts out the front panel 12 and the back panel 14 from the sheets 22, 24 following a template, an included drawing or a scored sheet. A cutout 15 is then formed in a lower part of the back panel 14 to allow extension of the electric cord 30 therethrough. The user also forms several through openings 17a, 17b, 17c, and 17d, some of which are suitable for passing the bolts/screws 54 therethrough.

The user then attaches the light clips 46 about the entire periphery of the inner surface 62 of the front panel 12. A small quantity of adhesive 57 is applied to the outer surface 49 of the attachment members 48 securing the clips 46 to the front panel 12.

The user then attaches the spacer blocks to the inner surface 62 of the front panel 12 using a small quantity of adhesive 57 applied to the back surface 51 of the spacer block 50. The user then secures the light members 40 with the clips 46 by pushing the base 41 of the light members 40 into the U-shaped channel formed by the engaging part 47.

Once all light members 40 are secured to the front panel 12, the user secures the back panel 14 to the stake 26 at the desired height along the length of the stake 26. The bolts 54 are used for extending through the apertures 34 and through the openings (17b and 17d) for engagement with the spacer blocks 50 and their threaded openings 52 (17a, 17b, 17c, and 17d). The apertures 17b and 17d are vertically aligned allowing the bolts 54 to pass through the wall 32 and then through the vertically aligned openings. Of course, in other yard sign configurations, there may be more vertically aligned apertures that can be used for engaging the back panel 14 to the stake 26.

The cord 30 is passed through the cutout 15 formed in the back panel 14. Although not shown, it will be understood that the cord 30 can be connected to an extension cord (not shown) placed in the yard or plugged directly into an AC outlet.

Once the front panel 12 and the back panel 14 are secured together in a spaced-apart parallel relationship and positioned on the stake 26, the yard sign 10 can be erected in a desired pre-selected location by pushing the lower end 38 of the stake 26 into the ground and using the cross bar 36 and a foot push. The yard sign 10 can be illuminated at night or during the day. The reflective light surface 68 of the back panel 14 allows the light rays to escape from the space between the panels 12 and 14 and illuminate the peripheral border 18, thus creating an illuminated yard sign of any desired shape or configuration.

If desired, the inner surface 62 of the front panel 12 can be made of a dark non-reflective color, for instance black. In this manner, the light rays will bounce off the reflective surface 68 of the back panel 14 and escape from the sign 10.

The yard sign of the present invention is waterproof and sturdy. It can be used numerous times to support a local sports team, event, political assembly, etc. depending on the type of a kit the user buys. If desired, the kit 20 can include the panels already pre-cut to the desired shape. The kit may contain more than two planar sheets if a more complex outdoor sign is desired.

Alternatively, the kit may contain one planar sheet, which is large enough to make two or more panels. The kit can also contain the front panel being provided with the clips installed about the periphery of the inner surface or the spaces for attachment of the clips and spacers imprinted on the inner surface of the front panel. The front panels can also be sold with the spacer blocks attached and the back panel—with the cord-receiving cutout and the bolt-receiving holes already made. The kit may also contain extra light elements to use as replacement lights.

Many other changes and modifications can be made in the present invention without departing from the spirit thereof. I, therefore, pray that my rights to the present invention be limited only by the scope of the appended claims.

I claim:

1. An outdoor sign apparatus, comprising:
a front panel having a front panel inner surface and a front panel outer surface;
a back panel having a back panel inner surface and a back panel outer surface;
a means for securing the front panel to the back panel in a spaced-apart parallel relationship such that the front panel inner surface faces the back panel inner surface;
an upright support detachably securable to the front panel and the back panel; and
an illumination assembly securable to the front panel inner surface.

2. The apparatus of claim 1, wherein the front panel has a pre-determined total surface area, the back panel has a pre-determined total surface area, wherein the back panel total surface area is greater than the front panel total surface area.

3. The apparatus of claim 1, wherein a peripheral border is defined by a peripheral edge of the back panel.

4. The apparatus of claim 1, said means for securing the front panel to the back panel in a spaced-apart parallel relationship comprising a plurality of threaded members, a plurality of spacer blocks affixed to the front panel inner surface and extending between the front panel inner surface and the back panel inner surface, said threaded members extending from the upright support through the back panel and threadably engaging the spacer blocks.

5. The apparatus of claim 4, wherein each of the spacer blocks is provided with a threaded opening suitable for matching threadable engagement with the threaded members.

6. The apparatus of claim 1, the illumination assembly comprising a plurality of light members connected in series and connectable to an external power source, and a plurality of clips securing the plurality of light members to the front panel inner surface.

7. The apparatus of claim 1, the front panel has a generally planar configuration.

8. The apparatus of claim 1, the front panel has a generally planar configuration.

9. The apparatus of claim 4, the upright support comprising an elongated body having a lower portion suitable for embedment into the ground.

10. The apparatus of claim 9, the upright stake comprising a transverse bar secured adjacent the lower portion.

11. The apparatus of claim 9, the elongated body having a generally U-shaped cross-section with a U-shaped groove extending along substantially along entire length of the elongated body.

12. The apparatus of claim 11, the illumination assembly comprising an electric cord for connecting the illumination assembly to the external power source, the cord being sized and shaped to fit into the U-shaped groove.

13. The apparatus of claim 12, the back panel being provided with a cutout to allow extension of the electric cord therethrough.

14. The apparatus of claim 9, said elongated body comprises a rear wall provided with a plurality of vertically spaced-apart openings, and wherein the threaded members extend through selected of the spaced-apart openings.

15. The apparatus of claim 1, the back panel inner surface being formed from a light-reflective material.

16. The apparatus of claim 1, the front panel inner surface being formed from a light non-reflective material.

17. An outdoor sign apparatus, comprising:
a planar front panel having a front panel inner surface, a front panel outer surface and a pre-determined front panel total surface area;
a planar back panel having a back panel inner surface, a back panel outer surface and a pre-determined back panel total surface area, the back panel total surface area being greater than the front panel total surface area;
a means for securing the front panel to the back panel in a spaced-apart parallel relationship such that the front panel inner surface faces the back panel inner surface;
an upright support member detachably securable to the front panel and the back panel; and
an illumination assembly securable to the front panel inner surface.

18. The apparatus of claim 17, said means for securing the front panel to the back panel in a spaced-apart parallel relationship comprising a plurality of threaded members, a plurality of spacer blocks affixed to the front panel inner surface and extending between the front panel inner surface and the back panel inner surface, said threaded members extending from the upright support through the back panel and threadably engaging the spacer blocks.

19. The apparatus of claim 18, wherein each of the spacer blocks is provided with a threaded opening suitable for matching threadable engagement with the threaded members.

20. The apparatus of claim 17, the illumination assembly comprising a plurality of light members connected in series and connectable to an external power source, a plurality of clips securing the plurality of light members to the front panel inner surface, and an electric cord adapted for connecting the plurality of light members to an external power source.

21. The apparatus of claim 17, wherein the upright support member comprises an elongated body having a lower portion suitable for embedment into the ground.

22. The apparatus of claim 21, the upright stake comprising a transverse bar secured adjacent the lower portion.

23. The apparatus of claim 22, wherein the transverse bar defines a foot push.

24. The apparatus of claim 19, the elongated body having a generally U-shaped cross-section with a U-shaped groove extending along substantially along entire length of the elongated body.

25. The apparatus of claim 24, wherein the U-shaped groove is adapted to receive at least a portion of the electric cord therein.

26. The apparatus of claim 21, said elongated body comprises a rear wall provided with a plurality of vertically spaced-apart openings, and wherein the threaded members extend through selected of the spaced-apart openings.

27. The apparatus of claim 17, the back panel inner surface being formed from a light-reflective material.

28. The apparatus of claim 17, the front panel inner surface being formed from a light non-reflective material.

29. A kit for making an outdoor sign, comprising:
a pair of planar sheets of weather-resistant material having an indicia corresponding to a desired shape of the outdoor sign, said indicia defining a front panel and a back panel;
an illumination assembly securable to the front panel and extending between the front panel and the back panel;
a plurality of spacer blocks adapted for mounting between the front panel and the back panel;
a pre-determined quantity of an adhesive material suitable for attaching the illumination assembly and the spacer blocks to the front panel; and
an upright stake for supporting the front panel and the back panel above ground.

30. The kit of claim 29, wherein the illumination assembly comprises a plurality of light members connected in series and connectable to an external power source, and a plurality of clips adapted securing the plurality of light members to an inner surface of the front panel.

31. The kit of claim 29, wherein the upright stake comprises an elongated body having a lower portion adapted for embedding into the ground.

32. The kit of claim 31, the elongated body having a back wall provided with a plurality of vertically spaced-apart openings.

33. The kit of claim 32, further comprising a plurality of threaded members adapted to extend through selective of the spaced-apart threaded openings, the back panel and engage with the spacer blocks when the spacer blocks secured to the front panel.

34. The kit of claim 33, wherein each of the spacer blocks is provided with a threaded opening suitable for matching threadable engagement with the threaded members.

35. The kit of claim 29, wherein one sheet of the pair of planar sheets has a light-reflective surface, said one sheet having indicia thereon for forming the back panel, and said light-reflective surface defining the back panel inner surface.

36. The kit of claim 35, wherein a second sheet of the pair of planar sheets has a light non-reflective surface, said second sheet having indicia thereon for forming the front panel, and said light non-reflective surface defining the inner panel inner surface.

37. The kit of claim 29, wherein the indicia comprises an outline of the front panel having a pre-determined total surface area and an outline of the back panel having a pre-determined surface area, and wherein the total surface of the back panel is greater than the total surface area of the front panel.

38. The kit of claim 29, wherein the indicia comprises an outline of a cutout in a lower part of the back panel.
